(19) United States
(12) Patent Application Publication
(10) Pub. No.: US 2026/0104523 A1
(43) Pub. Date: Apr. 16, 2026

(54) METHOD AND APPARATUS FOR SEISMIC IMAGING WITH VSP WHILE-DRILLING AND WELL-DRIVEN

(71) Applicant: PetroChina Company Limited, Beijing (CN)

(72) Inventors: Jiaqing Sun, Beijing (CN); Longjiang Kou, Beijing (CN); Jing Wang, Beijing (CN); Jintao Liu, Beijing (CN); Xiaowei Wang, Beijing (CN); Qin Su, Beijing (CN); Xiao Wang, Beijing (CN); Xingrong Xu, Beijing (CN); Baozhong Jin, Beijing (CN); Yue Ling, Beijing (CN)

(21) Appl. No.: 19/116,173

(22) PCT Filed: Sep. 25, 2023
(86) PCT No.: PCT/CN2023/121000

§ 371 Date: Mar. 27, 2025

(30) Foreign Application Priority Data
Sep. 30, 2022 (CN) 202211216892.X

(51) Int. Cl. G01V 1/30; G01V 1/46

(52) U.S. Cl. CPC G01V 1/305; G01V 1/307; G01V 1/46; G01V 2210/512; G01V 2210/6169; G01V 2210/6222

(57) ABSTRACT

The present disclosure discloses a method and apparatus for seismic imaging with VSP while-drilling and well-driven. The method includes: acquiring a seismic data processing result and logging data within a processing area range corresponding to a target well; optimizing and adjusting the seismic data processing result and the logging data to obtain anisotropic parameters for pre-stack depth migration; updating a seismic velocity of the target well with a VSP velocity as a constraint; performing iterative optimization on a VSP-driven corrected seismic velocity field to obtain an iteratively optimized seismic velocity field and anisotropic parameter field; migrating a pre-stack depth migration volume to obtain a migration result; performing post-stack frequency enhancement refinement on the migration result to obtain a migration result after the post-stack frequency enhancement refinement; and determining a maximum probability imaging position of the target well at a target reservoir.

The present application claims priority to a Chinese Patent Application No. 202211216892.X filed on Sep. 30, 2022, and entitled “Method and Apparatus for Seismic Imaging with VSP While Drilling and Well-Driven”, which is hereby incorporated by reference in its entirety.

### TECHNICAL FIELD

The present disclosure relates to the technical field of seismic while-drilling, and in particular to a method and apparatus for seismic imaging with VSP (Vertical Seismic Profile) while-drilling and well-driven.

### BACKGROUND

This section is intended to provide a background or context to the embodiments of the present disclosure recited in the claims. The description herein is not admitted to be the related art by virtue of its inclusion in this section.

Oil drilling is an underground project with high-investment and high-risk. When drilling is carried out, the vague knowledge of underground conditions brings great risks to drilling operations. Therefore, an exploration technique that detects various parameters of undrilled formations and locations of reservoir and faults (or fractures) is extremely important.

The earliest technique of seismic while-drilling is to use a drill bit as a seismic source signal and receive artificial seismic information in real time during the drilling process to detect underground geological conditions. However, due to high requirements on the process of the drill bit, this measurement method has not been able to achieve expected application effects. The VSP while-technique is a technique that moves a seismic source to the ground and installs a seismometer on a downhole drilling tool to receive the energy released by the ground seismic source. This technique cleverly avoids the problem of the drill bit, while maintaining the advantages of real-time measurement without wasting drilling time. However, this measurement method requires the use of professional downhole drilling tools, which is expensive, and requires high instrument stability during the measurement process, which is not conducive to large-scale promotion and application. After that, the pilot test of the seismic technique of the VSP while-drilling is carried out. In order to avoid high instrument costs, the conventional zero-offset VSP is used to obtain the latest underground geological information before drilling to a target formation, and then the conventional ground seismic data is used to predict various parameters and reservoir locations of an undrilled formation. This method is generally called VSP while-drilling and well-driven seismic technique, and has an advantage of implementing accurate positioning of targets by making good use of ground seismic data information. In addition, this technique greatly reduces acquisition costs and is conducive to large-scale application.

Based on data while-drilling alone, only information near a well point can be obtained. From the current tests, it can be found that combining ground seismic data with data while-drilling to jointly predict an undrilled formation can obtain more accurate results. However, drilling is a project that requires high timeliness, and ground seismic imaging is often very time-consuming, which is equivalent to increasing exploration costs.

Therefore, there is currently a lack of an efficient solution for seismic imaging with VSP while-drilling and well-driven.

### SUMMARY

In order to implement seismic imaging with VSP while-drilling and well-driven, an embodiment of the present disclosure provides a method for seismic imaging with VSP while-drilling and well-driven seismic, which has timeliness and high accuracy. The method includes:
acquiring a seismic data processing result and logging data within a processing area range corresponding to a target well;
optimizing and adjusting the seismic data processing result and the logging data to obtain anisotropic parameters for pre-stack depth migration;
updating a seismic velocity of the target well with a VSP velocity as a constraint to obtain updated anisotropic velocities;
performing, based on the anisotropic parameters, iterative optimization on a VSP-driven corrected seismic velocity field to obtain an iteratively optimized seismic velocity field and an iteratively optimized anisotropic parameter field;
migrating a pre-stack depth migration volume using the iteratively optimized seismic velocity field and the iteratively optimized anisotropic parameter field to obtain a migration result;
performing post-stack frequency enhancement refinement on the migration result to obtain a migration result after the post-stack frequency enhancement refinement; and
determining, according to the migration result after the post-stack frequency enhancement refinement, an imaging position of the target well at a target reservoir with a maximum probability.

In order to implement seismic imaging with VSP while-drilling and well-driven, an embodiment of the present disclosure further provides an apparatus for seismic imaging with VSP while-drilling and well-driven, which has timeliness and high accuracy. The apparatus includes:
a data acquisition module configured to acquire a seismic data processing result and logging data within a processing area range corresponding to a target well;
an optimization and adjustment module configured to optimize and adjust the seismic data processing result and the logging data to obtain anisotropic parameters for pre-stack depth migration;
a VSP-driven correction module configured to update a seismic velocity of the target well with a VSP velocity as a constraint to obtain updated anisotropic velocities;
an iterative optimization module configured to perform, based on the anisotropic parameters, iterative optimization on a VSP-driven corrected seismic velocity field to obtain an iteratively optimized seismic velocity field and an iteratively optimized anisotropic parameter field;
a migration module configured to migrate a pre-stack depth migration volume using the iteratively optimized seismic velocity field and the iteratively optimized anisotropic parameter field to obtain a migration result;
a post-stack frequency enhancement refinement module configured to perform post-stack frequency enhancement refinement on the migration result to obtain a migration result after the post-stack frequency enhancement refinement; and
an imaging position determination module configured to determine, according to the migration result after the post-stack frequency enhancement refinement, an imaging position of the target well at a target reservoir with a maximum probability.

An embodiment of the present disclosure further provides a computer device, including: a memory: a processor; and a computer program stored in the memory and executable on the processor, in which the processor implements the above method for seismic imaging with VSP while-drilling and well-driven when executing the computer program.

An embodiment of the present disclosure further provides a computer-readable storage medium, which stores a computer program. When executed by a processor, the computer program implements the above method for seismic imaging with VSP while-drilling and well-driven.

An embodiment of the present disclosure further provides a computer program product, which includes a computer program. When executed by a processor, the computer program implements the above method for seismic imaging with VSP while-drilling and well-driven.

In the embodiments of the present disclosure, the method includes: acquiring a seismic data processing result and logging data within a processing area range corresponding to a target well: optimizing and adjusting the seismic data processing result and the logging data to obtain anisotropic parameters for pre-stack depth migration: updating a seismic velocity of the target well with a VSP velocity as a constraint to obtain updated anisotropic velocities: performing, based on the anisotropic parameters, iterative optimization on a VSP-driven corrected seismic velocity field to obtain an iteratively optimized seismic velocity field and an iteratively optimized anisotropic parameter field: migrating a pre-stack depth migration volume using the iteratively optimized seismic velocity field and the iteratively optimized anisotropic parameter field to obtain a migration result: performing post-stack frequency enhancement refinement on the migration result to obtain a migration result after the post-stack frequency enhancement refinement; and determining, according to the migration result after the post-stack frequency enhancement refinement, an imaging position of the target well at a target reservoir with a maximum probability. The method includes: obtaining a VSP-driven corrected velocity by taking a VSP velocity as a constraint, and performing, based on the anisotropic parameters, iterative optimization on a VSP-driven corrected seismic velocity field to obtain an iteratively optimized seismic velocity field and an iteratively optimized anisotropic parameter field: migrating a pre-stack depth migration volume using the iteratively optimized seismic velocity field and the iteratively optimized anisotropic parameter field to obtain a migration result: performing post-stack frequency enhancement refinement on the migration result to obtain a migration result after the post-stack frequency enhancement refinement; and determining, according to the migration result after the post-stack frequency enhancement refinement, an imaging position of the target well at a target reservoir with a maximum probability. Compared with the technical solution of combining ground seismic data with data while-drilling in the related art, this method greatly improves the timeliness and accuracy of ground seismic imaging, reduces implementation costs of a VSP while-drilling seismic technique, and plays an important role in giving full play to the effect of the VSP while-drilling seismic technique, thereby improving the success rate of drilling and reducing costs and increasing the efficiency.

### BRIEF DESCRIPTION OF DRAWINGS

In order to illustrate the embodiments of the present disclosure or technical solutions in the related art more clearly, the drawings required for the illustration of the embodiments or the related art will be briefly described below. Obviously, the drawings in the following description are merely some embodiments of the present disclosure. A person skilled in the art can obtain other drawings based on these drawings without exerting inventive work.

FIG. 1 is a flow chart of a method for seismic imaging with VSP while-drilling and well-driven according to an embodiment of the present disclosure.

FIG. 2 is a plan view of a data collection range of seismic imaging processing with VSP while-drilling and well-driven according to the embodiment of the present disclosure.

FIG. 3 is a schematic diagram of a principle of checking according to seismic data processing result according to the embodiment of the present disclosure.

FIG. 4 is a schematic diagram of imaging before and after optimizing and adjusting the seismic data processing result according to the embodiment of the present disclosure.

FIG. 5 is a schematic diagram of a seismic velocity before and after VSP driving according to the embodiment of the present disclosure.

FIG. 6 is a schematic diagram of a comparison of an updated well point velocity before and after performing lateral interpolation and extrapolation using a lateral interpolation and extrapolation method, according to the embodiment of the present disclosure.

FIG. 7 is a schematic diagram of a comparison between a Delta value in an anisotropic parameter field established by the method of the present disclosure and a Delta value in the seismic data processing result, according to the embodiment of the present disclosure.

FIG. 8 is a schematic diagram of a comparison of an anisotropic parameter Epsilon before and after updating using a grid tomography iteration method provided by the present disclosure, according to the embodiment of the present disclosure.

FIG. 9 is a schematic diagram of a comparison of an igneous rock velocity before and after updating using an iterative updating method for a special attribute velocity provided by the present disclosure, according to the embodiment of the present disclosure.

FIG. 10 is a schematic diagram of a comparison of a migration result of a pre-stack depth migration volume before and after processing using a Kirchhoff integration method, according to the embodiment of the present disclosure.

FIG. 11 is a schematic diagram of analyzing an imaging position of a target reservoir using a target position quantitative analysis method according to the embodiment of the present disclosure.

FIG. 12 is a schematic diagram of an apparatus for seismic imaging with VSP while-drilling and well-driven according to the embodiment of the present disclosure.

FIG. 13 is a schematic diagram of a computer device according to the embodiment of the present disclosure.

### DESCRIPTION OF THE EMBODIMENTS

In order to make the objects, technical solutions and advantages of the embodiments of the present disclosure more clear, the embodiments of the present disclosure will be further described in detail below with reference to the drawings. Here, the exemplary embodiments of the present disclosure and illustrations thereof are used to illustrate the present disclosure, but are not intended to limit the present disclosure.

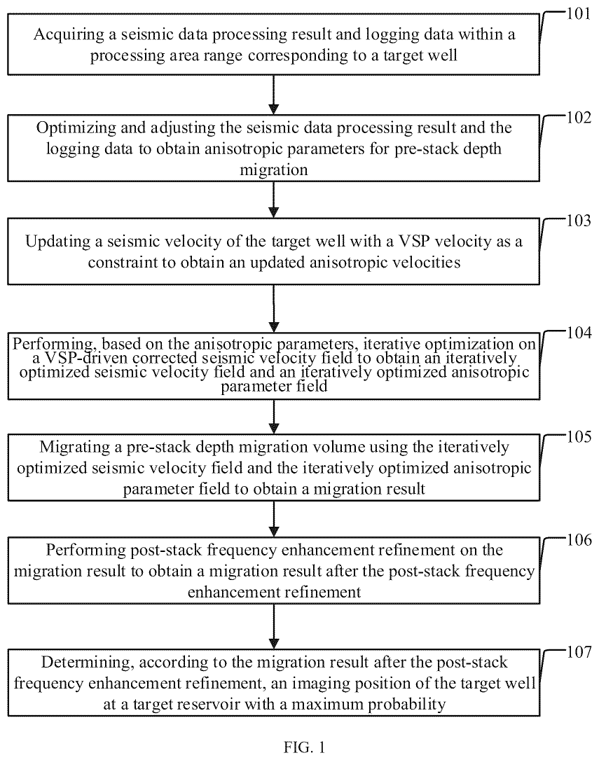

FIG. 1 is a flow chart of a method for seismic imaging with VSP while-drilling and well-driven according to an embodiment of the present disclosure. The flow chart includes:
step 101: acquiring a seismic data processing result and logging data within a processing area range corresponding to a target well;
step 102: optimizing and adjusting the seismic data processing result and the logging data to obtain anisotropic parameters for pre-stack depth migration;
step 103: updating a seismic velocity of the target well with a VSP velocity as a constraint to obtain updated anisotropic velocities;
step 104: performing, based on the anisotropic parameters, iterative optimization on a VSP-driven corrected seismic velocity field to obtain an iteratively optimized seismic velocity field and an iteratively optimized anisotropic parameter field;
step 105: migrating a pre-stack depth migration volume using the iteratively optimized seismic velocity field and the iteratively optimized anisotropic parameter field to obtain a migration result;
step 106: performing post-stack frequency enhancement refinement on the migration result to obtain a migration result after the post-stack frequency enhancement refinement; and
step 107: determining, according to the migration result after the post-stack frequency enhancement refinement, an imaging position of the target well at a target reservoir with a maximum probability.

The method provided in the embodiment of the present disclosure includes: obtaining a VSP-driven corrected velocity by taking a VSP velocity as a constraint, and performing, based on the anisotropic parameters, iterative optimization on a VSP-driven corrected seismic velocity field to obtain an iteratively optimized seismic velocity field and an iteratively optimized anisotropic parameter field: migrating a pre-stack depth migration volume using the iteratively optimized seismic velocity field and the iteratively optimized anisotropic parameter field to obtain a migration result: performing post-stack frequency enhancement refinement on the migration result to obtain a migration result after the post-stack frequency enhancement refinement; and determining, according to the migration result after the post-stack frequency enhancement refinement, an imaging position of the target well at a target reservoir with a maximum probability. Compared with the technical solution of combining ground seismic data with data while-drilling in the related art, this method greatly improves the timeliness and accuracy of ground seismic imaging, reduces implementation costs of a VSP while-drilling seismic technique, and plays an important role in giving full play to the effect of the VSP while-drilling seismic technique, thereby improving the success rate of drilling and reducing costs and increasing the efficiency.

That is, in the embodiment of the present disclosure, a VSP velocity (accurate depth and velocity information obtained by Vertical Seismic Profiling (VSP) while-drilling) is used as prior information to drive a seismic data processing result to implement rapid and accurate imaging, so as to determine an imaging position of a target well in a target reservoir with a maximum probability. This method belongs to the method of processing and interpreting seismic data in real time during the drilling process in the field of oil and gas exploration to optimize a drilling target, and is suitable for a target optimization and adjustment stage in the process of oil geophysical exploration drilling.

In specific implementation, a processing range of seismic imaging with VSP while-drilling and well-driven is determined according to a geological structure change around the target well, and the processing area range corresponding to the target well is determined. Then, the seismic data processing result and the logging data within the processing area range corresponding to the target well are obtained.

In an embodiment, the seismic data processing result includes one or any combination selected from a Common Midpoint (CMP) gather processing result, a pre-stack time migration result, a pre-stack depth migration result, pre-stack depth migration velocities, a pre-stack depth migration anisotropic parameter result, a pre-stack depth migration isotropic parameter result, and a pre-stack depth migration structural parameter result, and
the logging data includes one or any combination selected from well header information, well trajectory information, and well layering information of a forward drilling well and a peripheral well.

It should be pointed out that to obtain the most current logging data.

In an embodiment, after acquiring the seismic data processing result and the logging data within the processing area range corresponding to the target well, the method further includes:
checking whether there is noise affecting profile imaging in the CMP gather processing result, and if not, determining that the CMP gather processing result is reliable, in which the noise affecting the profile imaging including one or any combination selected from abnormal amplitude, multiple waves, migration arcing, and slant interference;
checking the pre-stack depth migration velocities, and determining that the pre-stack depth migration velocities are reliable when a velocity picking point of the pre-stack depth migration velocities are reasonable, gathers are flattened after normal-moveout correction, and a lateral variation of a velocity profile aligns with geological and geophysical rules; and
checking the reliability of the pre-stack depth migration anisotropic parameter result and the pre-stack depth migration isotropic parameter result by a spectrum of a migration profile of a target line around the well, an amplitude of the migration profile of the target line around the well, a coherent slice of the migration profile of the target line around the well, a collected CMP of the migration profile of the target line around the well, and a verifying migration of the migration velocity of the migration profile of the target line around the well (that is, restoring an original scene, comparing migration results and determining the reliability of the collected data) to obtain a reliability check result, and optimizing, according to the reliability check result, the pre-stack depth migration anisotropic parameter result and the pre-stack depth migration isotropic parameter result.

In the above steps, according to different data check results, reliable basic data are selected for preliminary optimization processing to better meet data requirements of VSP driving processing.

In an embodiment, optimizing, according to the reliability check result, the pre-stack depth migration anisotropic parameter result and the pre-stack depth migration isotropic parameter result incudes:
optimizing, if the pre-stack depth migration anisotropic parameter result is reliable, the pre-stack depth migration anisotropic parameter result;
optimizing, if the pre-stack depth migration anisotropic parameter result is unreliable and the pre-stack depth migration isotropic parameter result is reliable, the pre-stack depth migration isotropic parameter result, re-establishing a pre-stack depth migration anisotropic field, and performing pre-stack depth migration anisotropic depth migration; and
evaluating, if the pre-stack depth migration isotropic parameter result is still unreliable, the pre-stack time migration result, re-performing the pre-stack depth migration, and repeating the above steps until a reliable pre-stack depth migration isotropic parameter result is obtained.

In step 102, the seismic data processing result and the logging data are optimized and adjusted to obtain anisotropic parameters for pre-stack depth migration.

Due to the non-uniqueness of the seismic velocities, the velocity model obtained using the seismic data is not unique. In the process of progressive development of oil fields, new logging data and geological knowledge can be continuously obtained. These data and knowledge may be different from those when processing seismic data. It is necessary to establish a new velocity model that is consistent with new drilling information, guided by new geological knowledge and with comprehensive reference to seismic horizons and geological horizons.

Although previous ground seismic processing cannot provide an accurate velocity model, it can provide relatively accurate imaging velocity information. That is, a previous seismic velocity is an equivalent model of the actual velocity, Therefore, velocity update can save the time of re-performing pre-stack depth migration. According to a difference between a new velocity model (second velocity model) and a velocity model of the previous seismic processing (first velocity model), a residual traveltime tomography technique based on ray tracing is used to correct velocity and anisotropic parameter models. Residual traveltime tomography based on ray tracing, or time-preserving tomography, is mainly about solving a system of large-scale over-determined equations, which can be viewed as a set of linear constraints. There are two types of linear constraints in traveltime tomography: (a) setting each pair of tracing rays to zero traveltime error; and (b) setting a model error to an error of any layer depth and any anisotropic velocity parameter. An anisotropic parameter model that satisfies both types of constraints can be obtained by solving this system of linear equations, including seismic velocities, Thomsen parameters, and a depth of each layer.

In combination with the above process, the step of optimizing and adjusting the seismic data processing result and the logging data includes:
obtaining a first velocity model based on the seismic data processing result, and obtaining a second velocity model based on the seismic data processing result and current logging data;
obtaining a depth error of each formation between the first velocity model and the second velocity model;
establishing a traveltime tomography linear equation system based on the depth error of each formation; and
solving the traveltime tomography linear equation system to obtain the optimized anisotropic parameters for the pre-stack depth migration.

After the above optimization and adjustment, the seismic velocity and the anisotropic parameter field are directly used for anisotropic pre-stack depth migration. The convergence degree of target migration imaging is equivalent to that of the original anisotropic pre-stack depth migration result, but an imaging depth of each marker horizon after optimization and adjustment corresponds better to the new logging information.

In step 103, the seismic velocity of the target well is updated with the VSP velocity as a constraint to obtain updated anisotropic velocities, and the specific steps are as follows.

(1) A vertical seismic velocity above a bottom of the target well is updated with the VSP velocity as a constraint to obtain updated anisotropic velocities.

First, an initial velocity of the vertical seismic velocity is smoothed to eliminate the influence of excessive changes between layer velocities on the migration, and the corrected vertical seismic velocity above the bottom of the target well is obtained. By comparing the vertical seismic velocities before and after smoothing, it is found that there are still certain differences. The proportionality factor is obtained by performing operations on two vertical seismic velocities, and the proportionality factor is applied to generate a new VSP migration seismic velocity field, that is, new anisotropic velocities. This method can achieve efficient matching of the well-side seismic velocity and the VSP velocity, with a matching rate of more than 95%.

The specific implementation steps include:
A. obtaining a proportionality factor between a corrected vertical seismic velocity above the bottom of the target well and a well-side seismic velocity;
B. interpolating and extrapolating the proportionality factor using the VSP velocity as a constraint to obtain a proportionality factor data; and
C. obtaining new anisotropic velocities according to the proportionality factor data.

(2) The seismic velocity below the bottom of the target well is updated with a VSP velocity of a peripheral well of the target well as a constraint, the updated seismic velocity below the bottom of the target well is spliced with the updated anisotropic velocities to obtain an updated well point velocity.

The VSP logging acquisition depth is limited, and there is a velocity blind zone exists from below a VSP well bottom to a target point. In order to improve the accuracy of the seismic velocity below the a VSP well bottom and reduce depth errors, the velocity should be corrected by referring to the VSP velocity or sonic wave velocity of the peripheral well as a reference velocity.

The specific implementation steps include:
A. using the VSP velocity or a sonic wave velocity of the peripheral well of the target well as a reference velocity;
B. stretching or compressing a blind zone length of the reference velocity to be consistent with a length of the VSP velocity of the target well, that is, changing a sampling interval; and
C. splicing the updated seismic velocity below the bottom of the target well with the updated anisotropic velocities to obtain an updated well point velocity.

(3) Lateral interpolation and extrapolation is performed on the updated well point velocity with geosteering as a constraint to obtain a VSP-driven corrected seismic velocity field.

The vertical seismic velocity above the bottom of the target well is updated with the VSP velocity as a constraint and the seismic velocity below the bottom of the target well is updated with the VSP velocity of the peripheral well of the target well as a constraint. This can accurately ensure the longitudinal accuracy of the well point velocity. The VSP velocity can be extended to the range of velocity modeling by spatial interpolation and extrapolation of the lateral variation of the well point velocity with a geological horizon as a constraint, thereby improving the velocity accuracy of the entire work area.

The specific implementation steps are as follows.

A. First, the proportionality factor at the well point is interpolated and extrapolated to form a proportionality factor data.

The conventional interpolation methods all require accurate seismic horizons for constraints, and picking up seismic horizons is a time-consuming and labour-intensive task. In order to improve the interpolation efficiency, the present disclosure uses a seismic guided velocity interpolation technique for interpolation and extrapolation. This technique does not require seismic horizons, but instead uses the coherent amplitude trends of seismic imaging data entities for lateral constraints, which not only improves the efficiency but is also more applicable to seismic horizons data that are difficult to accurately interpret to obtain, thus avoiding errors caused by seismic horizon interpretation.

B. A collected raw seismic velocity is smoothed.

C. The VSP-driven corrected seismic velocity field is obtained by applying the proportionality factor data to the smoothed seismic velocity.

In step 104, based on the anisotropic parameters, the iterative optimization is performed on the VSP-driven corrected seismic velocity field to obtain an iteratively optimized seismic velocity field and an iteratively optimized anisotropic parameter field. After remodeling the seismic velocity using VSP velocity drive, the velocity error is reduced and more consistent with the actual underground geological conditions. However, the seismic velocity is a vertical seismic velocity and needs to be combined with the corresponding anisotropic parameters to obtain the seismic imaging velocity.

In an embodiment, performing, based on the anisotropic parameters, iterative optimization on a VSP-driven corrected seismic velocity field to obtain an iteratively optimized seismic velocity field and anisotropic parameter field includes the following steps.

(1) An initial anisotropic parameter field is established based on the anisotropic parameters.

The anisotropic parameters are obtained as described above. However, when a signal-to-noise ratio of the gather is relatively low, the grid tomography cannot achieve rapid update of the anisotropic parameters to obtain relatively accurate seismic imaging. Here, the initial Delta parameter field is considered to be mathematically operated to obtain an anisotropic parameter that better matches the VSP driving speed, so as to quickly implement accurate imaging of target string beads and reduce the number of iterations of grid tomography and layer-controlled grid tomography. The calculation formula is as follows.

$${δ}_{new} = [ \frac{{v}_{old}^{2} ( 1 + 2 {δ}_{old} )}{{v}_{new}^{2}} - 1 ] / 2 = \frac{1 + 2 {δ}_{old}}{2 {scal}^{2}} - 0.5 \qquad ( 2 )$$

In the formula, δ_{old} is an initial Delta parameter field, δ_{new} is an updated Delta parameter field, v_{old} is an initial velocity field, v_{new} is the updated velocity field in the previous step, and

$$scal = \frac{{v}_{new}}{{v}_{old}}$$

is the proportionality factor of the VSP driving velocity.

(2) The VSP-driven corrected seismic velocity field and the initial anisotropic parameter field are updated through grid tomography iteration to obtain an iteratively optimized seismic velocity field and an iteratively optimized anisotropic parameter field. The specific steps include the following.

A. A seismic velocity above the bottom of the target well in the VSP-driven corrected seismic velocity field is maintained.

This is because after the VSP-driven seismic velocity correction, the seismic velocity above the VSP well bottom is relatively accurate. Therefore, in the case of above the VSP well bottom, the seismic velocity is kept relatively unchanged during the iteration process, and each strong event of each deep migration CRP gather is flattened by iterating the anisotropic parameter to obtain more accurate pre-stack depth migration imaging. Based on the assumption of weak anisotropy, the value range is generally between −0.2 and 0.2, and it is relatively stable in the same formation. Generally, the relatively accurate shallow imaging can be obtained by one round of iteration, which meets the timeliness requirements of VSP driving processing.

B. Establishing, if there is a preset type attribute within the processing area range, based on the initial anisotropic parameter field using high-resolution grid tomography, a small-scale grid model of an igneous rock section to characterize an igneous rock velocity and perform iterative updating.

In this case, the preset type attribute can be a special lithology body such as igneous rock. Small grid iteration is performed on this special lithology body to eliminate the influence of the igneous rock velocity on the underlying formation structure and imaging. The VSP velocity well reflects the igneous rock velocity. However, the igneous rock velocity changes rapidly in the lateral, and the scarce well data cannot fully control the change of the igneous rock velocity. It is necessary to perform high-resolution grid tomography and establish a small-scale grid model of an igneous rock section to better characterize the igneous rock velocity.

C. Iterative updating is performed on a seismic velocity from the VSP well bottom to a target blind area in the VSP-driven corrected seismic velocity field by combining layer control and velocity scanning.

There is usually a set of marker layers with good lateral continuity from the VSP well bottom to the target blind area. The trend of the lateral velocity above the marker layers can be well controlled using the peripheral well and the velocity model. At this time, it is only necessary to perform layer-based tomography on the marker layers to iteratively update the velocity field. For the velocity below the marker layers, a velocity scanning method is used to ensure the imaging accuracy of the target point.

If there is no marker layer from the VSP well bottom to the target blind area, or there are few peripheral wells and the trend of the lateral velocity above the marker layers cannot be controlled, it is necessary to update the velocity above the VSP well bottom layer by layer from shallow to deep using the layer-based tomography method, so as to avoid the accumulation of errors in the layer velocity and the geometric shape of the reflection surface, and to improve the lateral velocity accuracy. Then, the velocity of the blind area below the VSP well bottom is scanned to ensure the imaging accuracy of the target point.

The anisotropic parameter field includes velocity, delta, epsilon, dip, azimuth, and the like.

In step 105, a pre-stack depth migration volume is migrated using the iteratively optimized seismic velocity field and the iteratively optimized anisotropic parameter field to obtain a migration result.

In recent years, a migration method based on a wave equation has made great progress. Reverse time migration can image any direction of wave propagation, including diving waves and multiple waves, can handle multipath problems, and can image overturning structures. It is a typical method of two-way wave equation migration and is also the most accurate migration algorithm. However, the VSP driving processing must consider not only accuracy but also timeliness. In the embodiment of the present disclosure, the Kirchhoff integration method is used to migrate the pre-stack depth migration volume. The Kirchhoff integration method is considered to be an efficient and practical pre-stack depth migration method. It has the characteristics of high migration angle, no frequency dispersion, less resource occupation and high implementation efficiency, and the integration method can adapt to the changing observation system and the undulating surface. Therefore, the Kirchhoff integration method is currently the most suitable migration method for the VSP driving processing.

In step 106, post-stack frequency enhancement refinement is performed on the migration result to obtain a migration result after the post-stack frequency enhancement refinement. At present, most exploration targets have low imaging signal-to-noise ratios and generally have heavy incidental phases, which makes reservoir imaging difficult to distinguish and requires appropriate post-stack processing. Post-stack processing methods with good amplitude preservation are usually performed on pre-stack gathers, which is time-consuming and cannot meet the timeliness requirements of VSP driving processing. It is necessary to explore fast and amplitude-preserving frequency enhancement refinement methods on post-stack profiles. The methods for improving the resolution of seismic data on a post-stack profile and compensating for the seismic wave energy loss caused by the attenuation of the underground medium mainly, include an inverse Q filtering method, a time-frequency analysis absorption compensation method, and the like. However, these methods have poor amplitude preservation. In order to solve the problems of fidelity and timeliness, the embodiment of the present disclosure provides an amplitude factor preservation technique to perform post-stack frequency enhancement refinement on the migration result.

The implementation steps of the amplitude factor preservation technique include:
A. extracting an amplitude factor from a direct migration profile of the migration result, in which the amplitude factor retains a relative amplitude relation of the profile and has good amplitude preservation;
B. performing frequency enhancement refinement such as inverse Q filtering on the post-stack migration data to obtain a frequency-enhanced post-stack data; and
C. restoring the amplitude factor to the frequency-enhanced post-stack data obtained in the previous step to ensure that the data retains the relative amplitude relation of the direct migration profile.

The amplitude factor preservation technique is used to ensure the amplitude preservation of data, and based on that, a method such as inverse Q filtering is used to improve the signal-to-noise ratio and resolution of a target layer, thereby greatly improving the target imaging.

In step 107, according to the migration result after the post-stack frequency enhancement refinement, an imaging position of the target well at a target reservoir with a maximum probability is determined. This process is target quantitative analysis, and the principle thereof is to perform local velocity scanning on the target reservoir, analyze different scanning results to perform quantitative analysis on the imaging position of the target reservoir, and finally determine the imaging position of the target reservoir with the maximum probability.

In an embodiment, determining, according to the migration result after the post-stack frequency enhancement refinement, the imaging position of the target well at a target reservoir with the maximum probability includes:
filling peripheral velocities of the target in the migration result with a constant velocity, and then performing imaging respectively, to obtain a first imaging result;
maintaining a lateral relative relation of the peripheral velocities of the target in the migration result unchanged, and performing percentage scanning (usually in the range of 90% to 110% and at an interval of 1%) and imaging respectively, to obtain a second imaging result;
maintaining current positions of the peripheral velocities of the target in the migration result unchanged, and performing a lateral relative relation scan and imaging respectively, to obtain a third imaging result, in this process, the scan is usually divided into four situations: a positive velocity in a main survey line direction increases, a reverse velocity in the main survey line direction increases, a positive velocity in a direction perpendicular to the main survey line increases, and a reverse velocity in the direction perpendicular to the main survey line increases, and then imaging is performed respectively;
drawing the first imaging result, the second imaging result, and the third imaging result (usually there are four drawing modes: energy distribution, maximum energy position distribution, and maximum energy brightness distribution); and
selecting the imaging position of the target reservoir with the maximum probability according to the drawing result.

Finally, the latest imaging position of the target reservoir with the maximum probability can be provided to the drilling personnel, and thus the well trajectory can be adjusted in time to ensure that the target reservoir is drilled, thereby achieving the purpose of improving the drilling success rate.

A specific example is provided below. The seismic data in the example comes from an oil field block A. According to an interpretation result of a ground seismic processing result completed in the early stage, a risk well MI was drilled in this block in a certain year. During the drilling process, it was found that the actual horizon differed from the predicted horizon by 100 meters, and it is difficult to drill into the target reservoir according to the original drilling trajectory. Therefore, when the fourth drilling section was completed, VSP logging was performed on the well. The drilling was stopped on site to wait for a new seismic data processing result, and a new drilling trajectory adjustment plan was formulated. According to the processing technique in the related art, even if the processing is expedited, the reprocessing of the seismic data processing result is estimated to take more than ten days, and the drilling stop time is estimated to exceed half a month, which will bring huge economic losses. However, after applying the method provided in the embodiment of the present disclosure, the processing time was compressed to 68 hours, and the drilling stop time was compressed to 3 days, saving a lot of time, as well as manpower and material costs. In the end, the well successfully drilled to the target reservoir and produced high yields after testing.

The embodiment was implemented specifically according to the following steps.

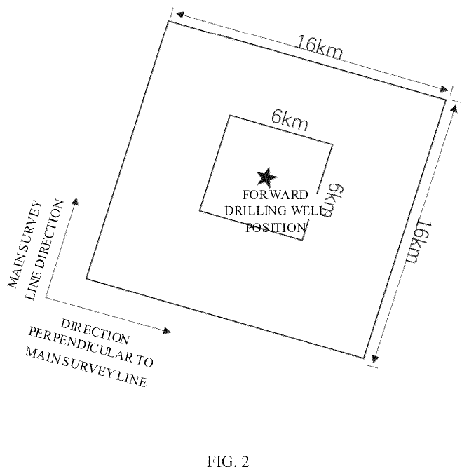

1. The work area is located in the desert area, where lateral variations of shallow formations are small and velocities have a strong correlation. In the original work area, 256 square kilometers around the well are selected to establish a work area processing range. FIG. 2 is a plan view of a data collection range of seismic imaging processing with VSP while-drilling and well-driven according to the embodiment of the present disclosure.

2. Ground seismic data and logging data of three nearby wells that have been drilled of a certain year within the processing range are collected.

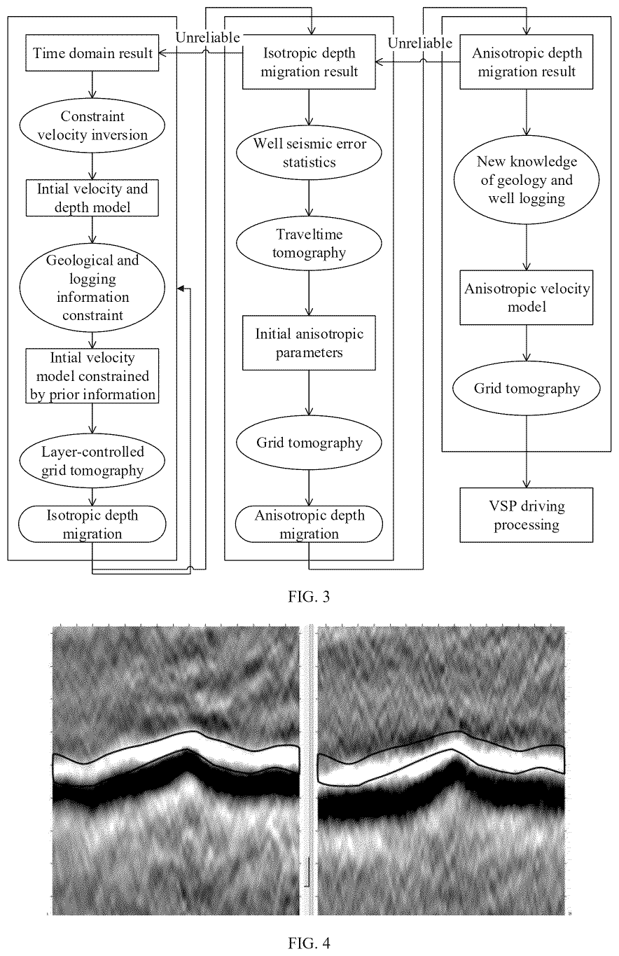

3. The method provided by the present disclosure is used to check the seismic data processing result, and finally pre-stack depth migration velocities and a pre-stack depth migration anisotropic parameter result are selected as reliable seismic data processing results. FIG. 3 is a schematic diagram of a principle of checking according to a seismic data processing result according to the embodiment of the present disclosure. If the anisotropic depth migration result is reliable, the anisotropic depth migration result is directly optimized, including obtaining an anisotropic velocity model through new knowledge of geology and well logging. Then, VSP driving processing is performed after network tomography. If the anisotropic depth migration result is unreliable, well seismic error statistics and traveltime tomography are performed to obtain initial anisotropic parameters, and then network tomography is performed to obtain an anisotropic depth migration. After obtaining the anisotropic depth migration result, the above steps are followed to determine whether the anisotropic depth migration result is valid. If an isotropic depth migration result is unreliable, a time domain result (that is, a pre-stack time migration result) is processed until an isotropic depth migration result is obtained. Then, it is determined whether the isotropic depth migration result is reliable. FIG. 4 is a schematic diagram of imaging before and after optimizing and adjusting the seismic data processing result according to the embodiment of the present disclosure (the left side is before optimization and adjustment, and the right side is after optimization and adjustment). It can be seen that after optimization and adjustment, the imaging effect is better.

4. A first velocity model and a second velocity model are established, and a traveltime tomography linear equation system is established and solved to obtain anisotropic parameters for pre-stack depth migration.

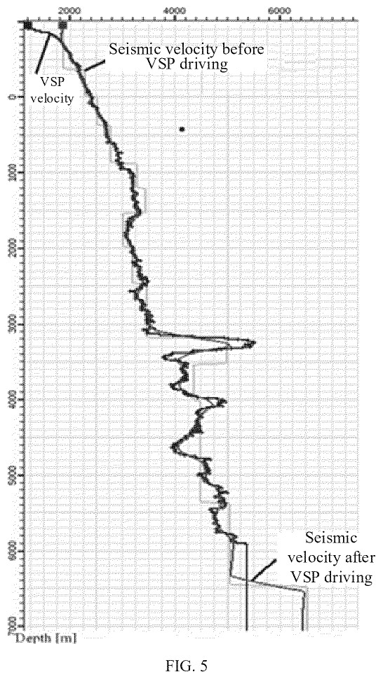

5. A vertical seismic velocity of the current well point is updated with the latest VSP velocity and depth obtained by processing the VSP logging data of the fourth drilling section being completed as constraints to obtain updated anisotropic velocities. FIG. 5 is a schematic diagram of a seismic velocity before and after VSP driving according to the embodiment of the present disclosure (the left side is before VSP driving, and the right side is after VSP driving). It can be seen that the seismic velocity after VSP driving is more accurate.

6. A seismic velocity below a bottom of the current well is updated with VSP velocities of three drilled wells as constraints, the updated seismic velocity below the bottom of the current well is spliced with the updated anisotropic velocities to obtain an updated well point velocity.

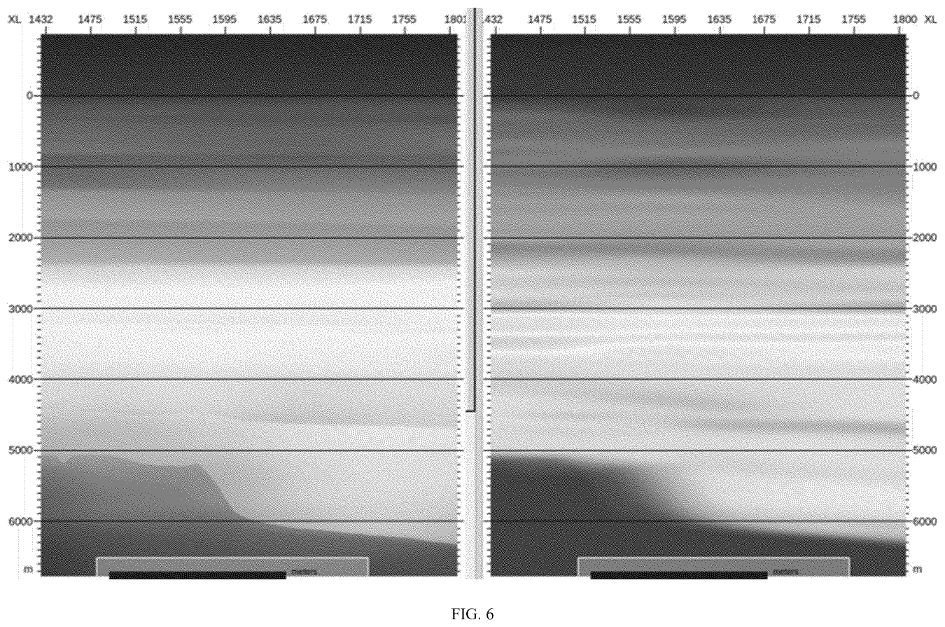

7. Lateral interpolation and extrapolation is performed on the updated well point velocity with geosteering as a constraint to obtain a VSP-driven corrected seismic velocity field. FIG. 6 is a schematic diagram of a comparison of an updated well point velocity before and after performing lateral interpolation and extrapolation using a lateral interpolation and extrapolation method, according to the embodiment of the present disclosure (the left side is before lateral interpolation and extrapolation, and the right side is after lateral interpolation and extrapolation).

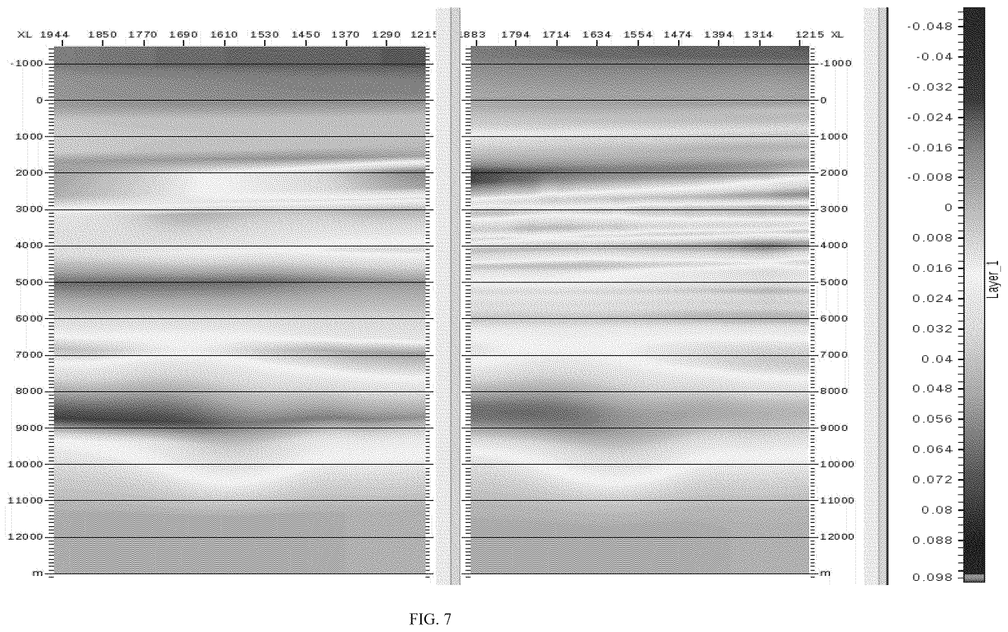

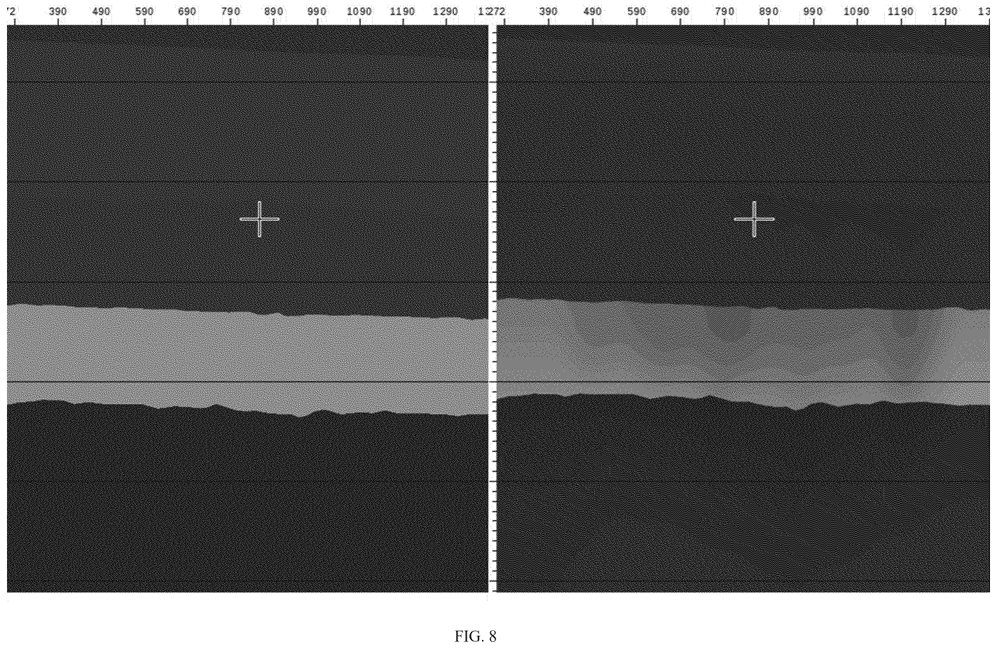

8. An initial anisotropic parameter field is established based on the anisotropic parameters. FIG. 7 is a schematic diagram of a comparison between a Delta value in an anisotropic parameter field established by the method of the present disclosure and a Delta value in the seismic data processing result, according to the embodiment of the present disclosure (the left side is a Delta value in the anisotropic parameter field established by the method of the present disclosure, and the right side is a Delta value in the seismic data processing result).

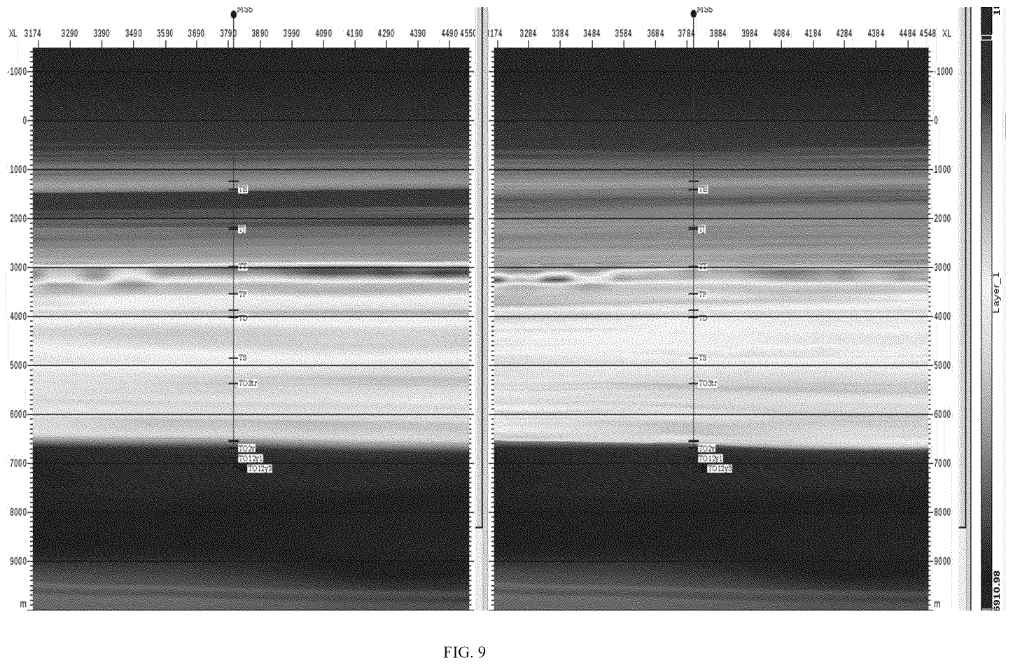

9. The VSP-driven corrected seismic velocity field and the initial anisotropic parameter field are updated through grid tomography iteration to obtain an iteratively optimized seismic velocity field and an iteratively optimized anisotropic parameter field. There is a set of igneous rocks with dramatic lateral variations in the Permian system in this work area. High-resolution grid tomography is used to establish a small-scale grid model of the igneous rock section to characterize the velocity of the igneous rock. The seismic velocity from the VSP well bottom to a target blind area is iterated by combining layer control and velocity scanning. FIG. 8 is a schematic diagram of a comparison of an anisotropic parameter Epsilon before and after updating using a grid tomography iteration method provided by the present disclosure, according to the embodiment of the present disclosure (the left side is before updating, and the right side is after updating). FIG. 9 is a schematic diagram of a comparison of an igneous rock velocity before and after updating using an iterative updating method for a special attribute velocity provided by the present disclosure, according to the embodiment of the present disclosure (the left side is before updating, and the right side is after updating).

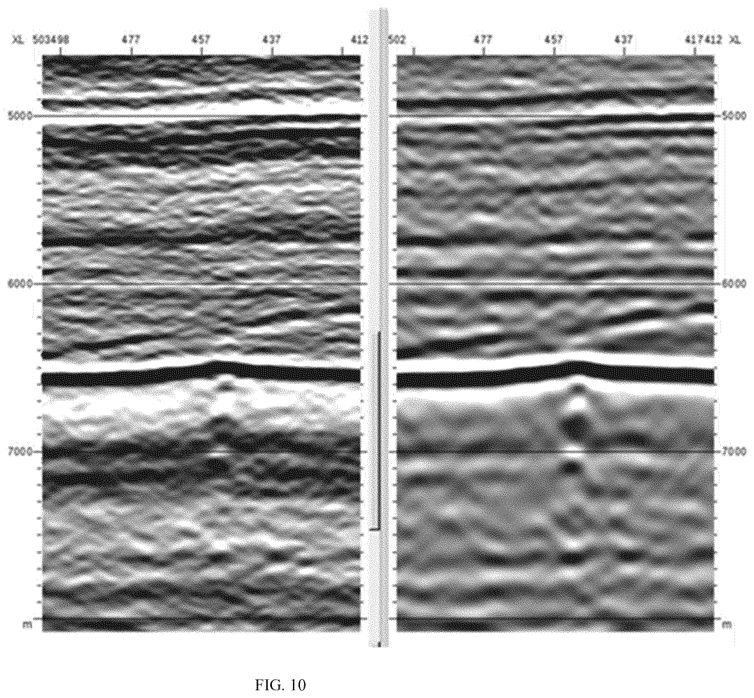

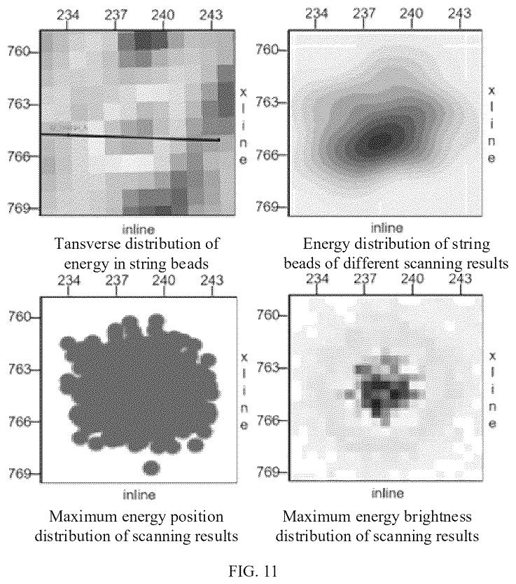

10. A pre-stack depth migration volume is migrated using the iteratively optimized seismic velocity field and the iteratively optimized anisotropic parameter field to obtain a migration result. FIG. 10 is a schematic diagram of a comparison of a migration result of a pre-stack depth migration volume before and after processing using a Kirchhoff integration method, according to the embodiment of the present disclosure (the left side is before processing, and the right side is after processing).

11. Post-stack frequency enhancement refinement is performed on the migration result using an amplitude factor preservation technique.

12. A target position quantitative analysis method is used to determine an imaging position of a target well in a target reservoir with a maximum probability. FIG. 11 is a schematic diagram of analyzing an imaging position of a target reservoir using a target position quantitative analysis method according to the embodiment of the present disclosure.

13. The latest imaging position of the target reservoir with the maximum probability is provided to the drilling personnel, and thus the well trajectory is adjusted in time to ensure that the target reservoir is drilled, thereby achieving the purpose of improving the drilling success rate.

In summary, the method provided by the embodiment of the present disclosure achieves the following beneficial effects.

First, an efficient method for seismic imaging with VSP while-drilling and well-driven is provided. The method greatly improves the timeliness and accuracy of ground seismic imaging, reduces implementation costs of a VSP while-drilling seismic technique, and plays an important role in giving full play to the effect of the VSP while-drilling seismic technique, thereby improving the success rate of drilling and reducing costs and increasing the efficiency.

Second, an evaluation system for seismic data processing results and well logging data is established to evaluate the collected seismic data processing results and well logging data. This can effectively and quickly select reliable seismic data processing results and well logging data, and prepare data for seismic imaging processing with VSP while-drilling.

Third, an efficient VSP while-drilling seismic velocity modeling method is established, which can quickly correct seismic velocity errors using new logging information and VSP velocities.

Fourth, an efficient method for obtaining anisotropic parameter fields is established to quickly implement accurate imaging of target string beads and reduce the number of iterations of grid tomography and layer-controlled grid tomography.

Fifth, an amplitude factor preservation technique is established to perform post-stack frequency enhancement refinement, which can effectively improve the signal-to-noise ratio and resolution of the target layer.

Sixth, a target point quantitative analysis method is established to perform local velocity scanning on the target reservoir, analyze different scanning results to perform quantitative analysis on the imaging position of the target reservoir, and finally determine the maximum probability imaging position of the target reservoir.

The application of actual data shows that the method provided by the embodiment of the present disclosure can effectively guide the optimization and adjustment of well trajectories, among which the trajectory adjustment of many wells exceeds 50 meters, which greatly reduces the risk of drilling projects. According to the average cost of 110 million RMB per 10,000 meters of drilling depth in Tarim, it is estimated that 600 million RMB of investment can be saved.

The VSP while-drilling seismic technique is not only applicable to various types of carbonate rocks, clastic rocks and other lithologic oil and gas reservoirs, but also to structural oil and gas reservoirs such as complex piedmont structural belts and complex fault zones. At the same time, the VSP while-drilling seismic technique is applicable to key exploration wells and evaluation wells in the exploration stage, and development wells in the development stage. The VSP while-drilling seismic technique has unique advantages in fine structural identification, improving exploration and development efficiency, and reducing exploration costs, and has very broad prospects and potential for promotion and application.

The embodiment of the present disclosure also provides an apparatus for seismic imaging with VSP while-drilling and well-driven, as described in the following embodiment. Since the principle of solving the problem by the apparatus is similar to that of the method for seismic imaging with VSP while-drilling and well-driven, the implementation of the apparatus can refer to the implementation of the method for seismic imaging with VSP while-drilling and well-driven, and repeated parts will not be described.

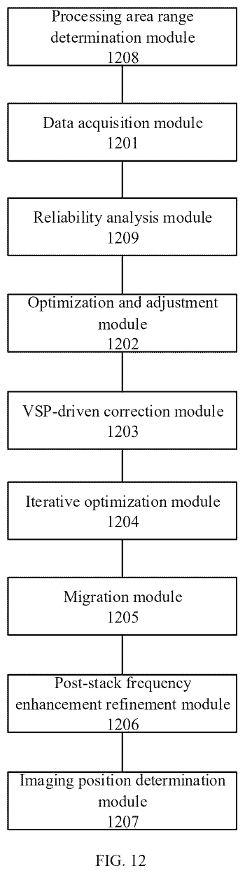

FIG. 12 is a schematic diagram of an apparatus for seismic imaging with VSP while-drilling and well-driven according to the embodiment of the present disclosure. The apparatus includes:
a data acquisition module 1201 configured to acquire a seismic data processing result and logging data within a processing area range corresponding to a target well;
an optimization and adjustment module 1202 configured to optimize and adjust the seismic data processing result and the logging data to obtain anisotropic parameters for pre-stack depth migration;
a VSP-driven correction module 1203 configured to update a seismic velocity of the target well with a VSP velocity as a constraint to obtain updated anisotropic velocities;
an iterative optimization module 1204 configured to perform, based on the anisotropic parameters, iterative optimization on a VSP-driven corrected seismic velocity field to obtain an iteratively optimized seismic velocity field and an iteratively optimized anisotropic parameter field;
a migration module 1205 configured to migrate a pre-stack depth migration volume using the iteratively optimized seismic velocity field and the iteratively optimized anisotropic parameter field to obtain a migration result;
a post-stack frequency enhancement refinement module 1206 configured to perform post-stack frequency enhancement refinement on the migration result to obtain a migration result after the post-stack frequency enhancement refinement; and
an imaging position determination module 1207 configured to determine, according to the migration result after the post-stack frequency enhancement refinement, an imaging position of the target well at a target reservoir with a maximum probability.

In an embodiment, the apparatus further includes a processing area range determination module 1208 configured to determine a seismic imaging processing range of VSP while-drilling and well-driven according to a geological structure change around the target well, and determine the processing area range corresponding to the target well.

In an embodiment, the seismic data processing result includes one or any combination selected from a CMP gather processing result, a pre-stack time migration result, a pre-stack depth migration result, pre-stack depth migration velocities, a pre-stack depth migration anisotropic parameter result, a pre-stack depth migration isotropic parameter result, and a pre-stack depth migration structural parameter result, and

the logging data includes one or any combination selected from well header information, well trajectory information, and well layering information of a forward drilling well and a peripheral well.

In an embodiment, the apparatus further includes a reliability analysis module 1209 configured to:
check, after acquiring the seismic data processing result and the logging data within the processing area range corresponding to the target well, whether there is noise affecting profile imaging in the CMP gather processing result, and if not, determine that the CMP gather processing result is reliable, in which the noise affecting the profile imaging includes one or any combination selected from abnormal amplitude, multiple waves, migration arcing, and slant interference,
check the pre-stack depth migration velocities, and determine that the pre-stack depth migration velocities are reliable when a velocity picking point of the pre-stack depth migration velocities are reasonable, gathers are flattened after normal-moveout correction, and a lateral variation of a velocity profile aligns with geological and geophysical rules, and
check the reliability of the pre-stack depth migration anisotropic parameter result and the pre-stack depth migration isotropic parameter result by checking a spectrum of a migration profile of a target line around the well, an amplitude of the migration profile of the target line around the well, a coherent slice of the migration profile of the target line around the well, a collected CMP of the migration profile of the target line around the well, and a verifying migration of the migration velocity of the migration profile of the target line around the well to obtain a reliability check result, and optimize, according to the reliability check result, the pre-stack depth migration anisotropic parameter result and the pre-stack depth migration isotropic parameter result.

In an embodiment, the reliability analysis module is specifically configured to:
optimize, if the pre-stack depth migration anisotropic parameter result is reliable, the pre-stack depth migration anisotropic parameter result,
optimize, if the pre-stack depth migration anisotropic parameter result is unreliable and the pre-stack depth migration isotropic parameter result is reliable, the pre-stack depth migration isotropic parameter result, re-establish a pre-stack depth migration anisotropic field, and perform pre-stack depth migration anisotropic depth migration, and
evaluate, if the pre-stack depth migration isotropic parameter result is still unreliable, the pre-stack time migration result, re-perform the pre-stack depth migration, and repeat the above steps until a reliable pre-stack depth migration isotropic parameter result is obtained.

In an embodiment, the optimization and adjustment module is specifically configured to:
obtain a first velocity model based on the seismic data processing result, and obtain a second velocity model based on the seismic data processing result and current logging data,
obtain a depth error of each formation between the first velocity model and the second velocity model,
establish a traveltime tomography linear equation system based on the depth error of each formation, and
solve the traveltime tomography linear equation system to obtain the anisotropic parameters for the pre-stack depth migration.

In an embodiment, the VSP-driven correction module is specifically configured to:
update a vertical seismic velocity above a bottom of the target well with the VSP velocity as a constraint to obtain updated anisotropic velocities,
update the seismic velocity below the bottom of the target well with a VSP velocity of a peripheral well of the target well as a constraint, splice the updated seismic velocity below the bottom of the target well with the updated anisotropic velocities to obtain an updated well point velocity, and
perform lateral interpolation and extrapolation on the updated well point velocity with geosteering as a constraint to obtain a VSP-driven corrected seismic velocity field.

In an embodiment, the VSP-driven correction module is specifically configured to:
obtain a proportionality factor between a corrected vertical seismic velocity above the bottom of the target well and a well-side seismic velocity,
interpolate and extrapolate the proportionality factor using the VSP velocity as a constraint to obtain a proportionality factor data, and
obtain new anisotropic velocities according to the proportionality factor data.

In an embodiment, the VSP-driven correction module is specifically configured to:
use the VSP velocity of the peripheral well of the target well as a reference velocity,
stretch or compress a blind zone length of the reference velocity to be consistent with a length of the VSP velocity of the target well, and
splice the updated seismic velocity below the bottom of the target well with the updated anisotropic velocities to obtain an updated well point velocity.

In an embodiment, the iterative optimization module is specifically configured to:
establish an initial anisotropic parameter field based on the anisotropic parameters, and
update the VSP-driven corrected seismic velocity field and the initial anisotropic parameter field through grid tomography iteration to obtain an iteratively optimized seismic velocity field and an iteratively optimized anisotropic parameter field.

In an embodiment, the iterative optimization module is specifically configured to:
establish, if there is a preset type attribute within the processing area range, based on the initial anisotropic parameter field using high-resolution grid tomography, a small-scale grid model of an igneous rock section to characterize an igneous rock velocity and perform iterative updating, and
perform iterative updating on a velocity from a VSP well bottom to a target blind area in the VSP-driven corrected seismic velocity field by combining layer control and velocity scanning.

In an embodiment, the post-stack frequency enhancement refinement module is specifically configured to perform post-stack frequency enhancement refinement on the migration result using an amplitude factor preservation technique.

In an embodiment, the imaging position determination module is specifically configured to:
fill peripheral velocities of the target in the migration result with a constant velocity, and then perform imaging respectively, to obtain a first imaging result,
maintain a lateral relative relation of the peripheral velocities of the target in the migration result unchanged, and perform percentage scanning and imaging respectively, to obtain a second imaging result,
maintain current positions of the peripheral velocities of the target in the migration result unchanged, and perform a lateral relative relation scan and imaging respectively, to obtain a third imaging result,
draw the first imaging result, the second imaging result, and the third imaging result, and
select the imaging position of the target reservoir with the maximum probability according to the drawing result.

In summary, the apparatus provided by the embodiment of the present disclosure achieves the following beneficial effects.

First, an efficient method for seismic imaging with VSP while-drilling and well-driven is provided. The method greatly improves the timeliness and accuracy of ground seismic imaging, reduces implementation costs of a VSP while-drilling seismic technique, and plays an important role in giving full play to the effect of the VSP while-drilling seismic technique, thereby improving the success rate of drilling and reducing costs and increasing the efficiency.

Second, an evaluation system for seismic data processing results and well logging data is established to evaluate the collected seismic data processing results and well logging data. This can effectively and quickly select reliable seismic data processing results and well logging data, and prepare data for seismic imaging processing with VSP while-drilling.

Third, an efficient VSP while-drilling seismic velocity modeling method is established, which can quickly correct seismic velocity errors using new logging information and VSP velocities.

Fourth, an efficient method for obtaining anisotropic parameter fields is established to quickly implement accurate imaging of target string beads and reduce the number of iterations of grid tomography and layer-controlled grid tomography.

Fifth, an amplitude factor preservation technique is established to perform post-stack frequency enhancement refinement, which can effectively improve the signal-to-noise ratio and resolution of the target layer.

Sixth, a target point quantitative analysis method is established to perform local velocity scanning on the target reservoir, analyze different scanning results to perform quantitative analysis on the imaging position of the target reservoir, and finally determine the maximum probability imaging position of the target reservoir.

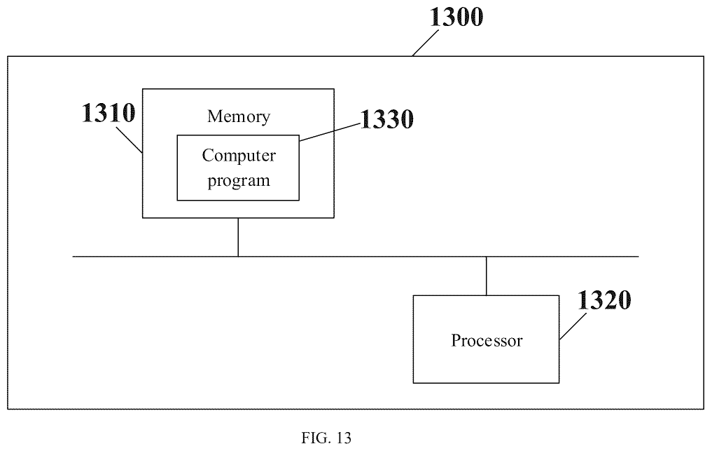

An embodiment of the present disclosure further provides a computer device. FIG. 13 is a schematic diagram of a computer device according to the embodiment of the present disclosure. A computer device 1300 includes a memory 1310, a processor 1320, and a computer program 1330 stored in the memory 1310 and executable on the processor 1320. The processor 1320 implements the above method for seismic imaging with VSP while-drilling and well-driven when executing the computer program 1330.

An embodiment of the present disclosure further provides a computer-readable storage medium, which stores a computer program. When executed by a processor, the computer program implements the above method for seismic imaging with VSP while-drilling and well-driven.

An embodiment of the present disclosure further provides a computer program product, which includes a computer program. When executed by a processor, the computer program implements the above method for seismic imaging with VSP while-drilling and well-driven.

It should be understood by those skilled in the art that the embodiments of the present disclosure may be provided as a method, a system, or a computer program product. Therefore, the present disclosure may take the form of a complete hardware embodiment, a complete software embodiment, or an embodiment combining software and hardware. Moreover, the present disclosure may take the form of a computer program product implemented on one or more computer-usable storage media (including but not limited to disk storage, CD-ROM, optical storage, and the like) including a computer-usable program code.

The present disclosure is described with reference to a flow chart and/or block diagram of the method, apparatus (system), and computer program product according to the embodiments of the present disclosure. It should be understood that each process and/or box in the flow chart and/or block diagram, as well as a combination of a process and/or box in the flow chart and/or block diagram, can be implemented by computer program instructions. These computer program instructions can be provided to a processor of a general-purpose computer, a special-purpose computer, an embedded processor or other programmable data processing device to produce a machine, such that the instructions executed by the processor of the computer or other programmable data processing device produce a device for implementing the functions specified in one or more processes in the flow chart and/or one or more boxes in the block diagram.

These computer program instructions may also be stored in a computer-readable memory that can guide a computer or other programmable data processing device to operate in a specific manner, such that the instructions stored in the computer-readable memory produce a manufactured product including an instruction device that implements the functions specified in one or more processes in the flow chart and/or one or more boxes in the block diagram.

These computer program instructions may also be loaded onto a computer or other programmable data processing device such that a series of operational steps are executed on the computer or other programmable device to produce a computer-implemented process, so that the instructions executed on the computer or other programmable device provide steps for implementing the functions specified in one or more processes in the flow chart and/or one or more boxes in the block diagram.

The objects, technical solutions and beneficial effects of the present disclosure are further described in detail through the specific embodiments described above. It should be understood that the above descriptions are merely specific embodiments of the present disclosure and are not intended to limit the scope of protection of the present disclosure. Any refinements, equivalent substitutions, improvements, and the like made within the spirit and principles of the present disclosure should be included in the scope of protection of the present disclosure.

1. A method for seismic imaging with VSP while-drilling and well-driven, the method comprising:
acquiring a seismic data processing result and logging data within a processing area range corresponding to a target well;
optimizing and adjusting the seismic data processing result and the logging data to obtain anisotropic parameters for pre-stack depth migration;
updating a seismic velocity of the target well with a Vertical Seismic Profile (VSP) velocity as a constraint to obtain updated anisotropic velocities;
performing, based on the anisotropic parameters, iterative optimization on a VSP-driven corrected seismic velocity field to obtain an iteratively optimized seismic velocity field and an iteratively optimized anisotropic parameter field;
migrating a pre-stack depth migration volume using the iteratively optimized seismic velocity field and the iteratively optimized anisotropic parameter field to obtain a migration result;
performing post-stack frequency enhancement refinement on the migration result to obtain a migration result after the post-stack frequency enhancement refinement; and
determining, according to the migration result after the post-stack frequency enhancement refinement, an imaging position of the target well at a target reservoir with a maximum probability.

2. The method according to claim 1, further comprising:
determining a seismic imaging processing range of VSP while-drilling and well-driven according to a geological structure change around the target well, and determining the processing area range corresponding to the target well.

3. The method according to claim 1, wherein the seismic data processing result comprises one or any combination selected from a Common Midpoint (CMP) gather processing result, a pre-stack time migration result, a pre-stack depth migration result, pre-stack depth migration velocities, a pre-stack depth migration anisotropic parameter result, a pre-stack depth migration isotropic parameter result, and a pre-stack depth migration structural parameter result, and
the logging data comprises one or any combination selected from well header information, well trajectory information, and well layering information of a forward drilling well and a peripheral well.

4. The method according to claim 3, after acquiring the seismic data processing result and the logging data within the processing area range corresponding to the target well, the method further comprising:
checking whether there is noise affecting profile imaging in the CMP gather processing result, and if not, determining that the CMP gather processing result is reliable, wherein the noise affecting the profile imaging comprises one or any combination selected from abnormal amplitude, multiple waves, migration arcing, and slant interference,
checking the pre-stack depth migration velocities, and determining that the pre-stack depth migration velocities are reliable when a velocity picking point of the pre-stack depth migration velocities are reasonable, gathers are flattened after normal-moveout correction, and a lateral variation of a velocity profile aligns with geological and geophysical rules, and
checking the reliability of the pre-stack depth migration anisotropic parameter result and the pre-stack depth migration isotropic parameter result by a spectrum of a migration profile of a target line around the well, an amplitude of the migration profile of the target line around the well, a coherent slice of the migration profile of the target line around the well, a collected CMP of the migration profile of the target line around the well, and a verifying migration of the migration velocity of the migration profile of the target line around the well to obtain a reliability check result, and optimizing, according to the reliability check result, the pre-stack depth migration anisotropic parameter result and the pre-stack depth migration isotropic parameter result.

5. The method according to claim 4, wherein optimizing, according to the reliability check result, the pre-stack depth migration anisotropic parameter result and the pre-stack depth migration isotropic parameter result comprises:
optimizing, if the pre-stack depth migration anisotropic parameter result is reliable, the pre-stack depth migration anisotropic parameter result,
optimizing, if the pre-stack depth migration anisotropic parameter result is unreliable and the pre-stack depth migration isotropic parameter result is reliable, the pre-stack depth migration isotropic parameter result, re-establishing a pre-stack depth migration anisotropic field, and performing pre-stack depth migration anisotropic depth migration, and
evaluating, if the pre-stack depth migration isotropic parameter result is still unreliable, the pre-stack time migration result, re-performing the pre-stack depth migration, and repeating the above steps until a reliable pre-stack depth migration isotropic parameter result is obtained.

6. The method according to claim 1, wherein optimizing and adjusting the seismic data processing result and the logging data to obtain the anisotropic parameters for pre-stack depth migration comprises:
obtaining a first velocity model based on the seismic data processing result, and obtaining a second velocity model based on the seismic data processing result and current logging data,
obtaining a depth error of each formation between the first velocity model and the second velocity model,
establishing a traveltime tomography linear equation system based on the depth error of each formation, and
solving the traveltime tomography linear equation system to obtain the anisotropic parameters for the pre-stack depth migration.

7. The method according to claim 1, wherein updating a seismic velocity of the target well with a VSP velocity as a constraint to obtain updated anisotropic velocities comprises:
updating a vertical seismic velocity above a bottom of the target well with the VSP velocity as a constraint to obtain updated anisotropic velocities,
updating the seismic velocity below the bottom of the target well with a VSP velocity of a peripheral well of the target well as a constraint, splicing the updated seismic velocity below the bottom of the target well with the updated anisotropic velocities to obtain an updated well point velocity, and
performing lateral interpolation and extrapolation on the updated well point velocity with geosteering as a constraint to obtain a VSP-driven corrected seismic velocity field.

8. The method according to claim 1, wherein updating the vertical seismic velocity above a bottom of the target well with the VSP velocity as a constraint to obtain the updated anisotropic velocities comprises:
obtaining a proportionality factor between a corrected vertical seismic velocity above the bottom of the target well and a well-side seismic velocity,
interpolating and extrapolating the proportionality factor using the VSP velocity as a constraint to obtain a proportionality factor data, and
obtaining new anisotropic velocities according to the proportionality factor data.

9. The method according to claim 8, wherein updating the seismic velocity below the bottom of the target well with a VSP velocity of a peripheral well of the target well as a constraint, splicing the updated seismic velocity below the bottom of the target well with the updated anisotropic velocities to obtain an updated well point velocity comprises:
using the VSP velocity or a sonic wave velocity of the peripheral well of the target well as a reference velocity,
stretching or compressing a blind zone length of the reference velocity to be consistent with a length of the VSP velocity of the target well, and
splicing the updated seismic velocity below the bottom of the target well with the updated anisotropic velocities to obtain the updated well point velocity.

10. The method according to claim 1, wherein performing, based on the anisotropic parameters, iterative optimization on a VSP-driven corrected seismic velocity field to obtain the iteratively optimized seismic velocity field and the iteratively optimized anisotropic parameter field comprises:
establishing an initial anisotropic parameter field based on the anisotropic parameters, and
updating the VSP-driven corrected seismic velocity field and the initial anisotropic parameter field through grid tomography iteration to obtain the iteratively optimized seismic velocity field and the iteratively optimized anisotropic parameter field.

11. The method according to claim 10, wherein updating the VSP-driven corrected seismic velocity field and the initial anisotropic parameter field through grid tomography iteration comprises:
maintaining a seismic velocity above the bottom of the target well in the VSP-driven corrected seismic velocity field,
establishing, if there is a preset type attribute within the processing area range, based on the initial anisotropic parameter field using high-resolution grid tomography, a small-scale grid model of an igneous rock section to characterize an igneous rock velocity and perform iterative updating, and
performing iterative updating on a seismic velocity from a VSP well bottom to a target blind area in the VSP-driven corrected seismic velocity field by combining layer control and velocity scanning.

12. The method according to claim 1, wherein performing post-stack frequency enhancement refinement on the migration result comprises:
performing post-stack frequency enhancement refinement on the migration result using an amplitude factor preservation technique.

13. The method according to claim 1, wherein determining, according to the migration result after the post-stack frequency enhancement refinement, the imaging position of the target well at a target reservoir with the maximum probability comprises:
filling peripheral velocities of the target in the migration result with a constant velocity, and then performing imaging respectively, to obtain a first imaging result,
maintaining a lateral relative relation of the peripheral velocities of the target in the migration result unchanged, and performing percentage scanning and imaging respectively, to obtain a second imaging result,
maintaining current positions of the peripheral velocities of the target in the migration result unchanged, and performing a lateral relative relation scan and imaging respectively, to obtain a third imaging result,
drawing the first imaging result, the second imaging result, and the third imaging result, and selecting the imaging position of the target reservoir with the maximum probability according to the drawing result.

14. An apparatus for seismic imaging with VSP while-drilling VSP and well-driven, the apparatus comprising:
a data acquisition module configured to acquire a seismic data processing result and logging data within a processing area range corresponding to a target well;
an optimization and adjustment module configured to optimize and adjust the seismic data processing result and the logging data to obtain anisotropic parameters for pre-stack depth migration;
a VSP-driven correction module configured to update a seismic velocity of the target well with a Vertical Seismic Profile (VSP) velocity as a constraint to obtain updated anisotropic velocities;
an iterative optimization module configured to perform, based on the anisotropic parameters, iterative optimization on a VSP-driven corrected seismic velocity field to obtain an iteratively optimized seismic velocity field and an iteratively optimized anisotropic parameter field;
a migration module configured to migrate a pre-stack depth migration volume using the iteratively optimized seismic velocity field and the iteratively optimized anisotropic parameter field to obtain a migration result;
a post-stack frequency enhancement refinement module configured to perform post-stack frequency enhancement refinement on the migration result to obtain a migration result after the post-stack frequency enhancement refinement; and
an imaging position determination module configured to determine, according to the migration result after the post-stack frequency enhancement refinement, an imaging position of the target well at a target reservoir with a maximum probability.

15. (canceled)

16. The apparatus according to claim 14, wherein the seismic data processing result comprises one or any combination selected from a Common Midpoint (CMP) gather processing result, a pre-stack time migration result, a pre-stack depth migration result, pre-stack depth migration velocities, a pre-stack depth migration anisotropic parameter result, a pre-stack depth migration isotropic parameter result, and a pre-stack depth migration structural parameter result, and
the logging data comprises one or any combination selected from well header information, well trajectory information, and well layering information of a forward drilling well and a peripheral well;
wherein the apparatus further comprises a reliability analysis module configured to;
check, after acquiring the seismic data processing result and the logging data within the processing area range corresponding to the target well, whether there is noise affecting profile imaging in the CMP gather processing result, and if not, determine that the CMP gather processing result is reliable, wherein the noise affecting the profile imaging comprises one or any combination selected from abnormal amplitude, multiple waves, migration arcing, and slant interference,
check the pre-stack depth migration velocities, and determine that the pre-stack depth migration velocities are reliable when a velocity picking point of the pre-stack depth migration velocities are reasonable, gathers are flattened after normal-moveout correction, and a lateral variation of a velocity profile aligns with geological and geophysical rules, and
check the reliability of the pre-stack depth migration anisotropic parameter result and the pre-stack depth migration isotropic parameter result by checking a spectrum of a migration profile of a target line around the well, an amplitude of the migration profile of the target line around the well, a coherent slice of the migration profile of the target line around the well, a collected CMP of the migration profile of the target line around the well, and a verifying migration of the migration velocity of the migration profile of the target line around the well to obtain a reliability check result, and optimize, according to the reliability check result, the pre-stack depth migration anisotropic parameter result and the pre-stack depth migration isotropic parameter result.

17-18. (canceled)

19. The apparatus according to claim 14, wherein the optimization and adjustment module is configured to:
obtain a first velocity model based on the seismic data processing result, and obtain a second velocity model based on the seismic data processing result and current logging data,
obtain a depth error of each formation between the first velocity model and the second velocity model,
establish a traveltime tomography linear equation system based on the depth error of each formation, and
solve the traveltime tomography linear equation system to obtain the anisotropic parameters for the pre-stack depth migration.

20. The apparatus according to claim 14, wherein the VSP-driven correction module is configured to:
update a vertical seismic velocity above a bottom of the target well with the VSP velocity as a constraint to obtain updated anisotropic velocities,
update the seismic velocity below the bottom of the target well with a VSP velocity of a peripheral well of the target well as a constraint, splice the updated seismic velocity below the bottom of the target well with the updated anisotropic velocities to obtain an updated well point velocity, and
perform lateral interpolation and extrapolation on the updated well point velocity with geosteering as a constraint to obtain a VSP-driven corrected seismic velocity field.

21-22. (canceled)

23. The apparatus according to claim 14, wherein the iterative optimization module is configured to:
establish an initial anisotropic parameter field based on the anisotropic parameters, and
update the VSP-driven corrected seismic velocity field and the initial anisotropic parameter field through grid tomography iteration to obtain the iteratively optimized seismic velocity field and the iteratively optimized anisotropic parameter field.

24-25. (canceled)

26. The apparatus according to claim 14, wherein the imaging position determination module is configured to:
fill peripheral velocities of the target in the migration result with a constant velocity, and then perform imaging respectively, to obtain a first imaging result,
maintain a lateral relative relation of the peripheral velocities of the target in the migration result unchanged, and perform percentage scanning and imaging respectively, to obtain a second imaging result,
maintain current positions of the peripheral velocities of the target in the migration result unchanged, and perform a lateral relative relation scan and imaging respectively, to obtain a third imaging result,
draw the first imaging result, the second imaging result, and the third imaging result, and
select then imaging position of the target reservoir with the maximum probability according to the drawing result.

27. A computer device, comprising:
a memory;
a processor; and
a computer program stored in the memory and executable on the processor, wherein when executing the computer program, the processor implements a method for seismic imaging with VSP while-drilling and well-driven,
wherein the method for seismic imaging with VSP while-drilling and well-driven comprises:
acquiring a seismic data processing result and logging data within a processing area range corresponding to a target well;
optimizing and adjusting the seismic data processing result and the logging data to obtain anisotropic parameters for pre-stack depth migration;
updating a seismic velocity of the target well with a Vertical Seismic Profile (VSP) velocity as a constraint to obtain updated anisotropic velocities;
performing, based on the anisotropic parameters, iterative optimization on a VSP-driven corrected seismic velocity field to obtain an iteratively optimized seismic velocity field and an iteratively optimized anisotropic parameter field;
migrating a pre-stack depth migration volume using the iteratively optimized seismic velocity field and the iteratively optimized anisotropic parameter field to obtain a migration result;
performing post-stack frequency enhancement refinement on the migration result to obtain a migration result after the post-stack frequency enhancement refinement; and
determining, according to the migration result after the post-stack frequency enhancement refinement, an imaging position of the target well at a target reservoir with a maximum probability.

28-29. (canceled)
